(19) United States
(12) Patent Application Publication
(10) Pub. No.: US 2013/0007588 A1
(43) Pub. Date: Jan. 3, 2013

(54) SYSTEMS AND METHODS FOR GLOBALIZING WEB APPLICATIONS

(75) Inventors: Liang Guo, Beijing (CN); Jing Li, Beijing (CN); CongPeng Ma, Epping (AU); Wanjun Wang, Cary, NC (US); Xuqin Zhao, Beijing (CN)

(73) Assignee: INTERNATIONAL BUSINESS MACHINES CORPORATION, Armonk, NY (US)

(21) Appl. No.: 13/173,388

(22) Filed: Jun. 30, 2011

(51) Int. Cl. G06F 17/00

(52) U.S. Cl. 715/234

(57) ABSTRACT

Described are a system and method for testing a software application. Elements of a web document under test loaded in a web browser are identified. The elements are output to a plurality of string processors. The string processors determine one or more accessible strings of text and locale-sensitive information from the elements. The accessible strings are validated to determine whether the strings are at least one of correctly pseudo-translated and properly formatted.

### TECHNICAL FIELD

The present inventive concepts relate generally to software globalization, and more specifically, to systems and methods for the global verification testing of web applications.

### BACKGROUND

Web application products are typically offered to customers worldwide, requiring them to be available in different regional languages. Global verification testing (GVT) is a well-known approach for internationalization testing of such products so that they can perform properly when modified for use in different languages and locales. In particular, global verification testing (GVT) validates whether the contents of a web application are correctly translated into other languages and that locale-sensitive data is properly formatted for display according to the locale. For example, GVT can verify whether text strings extracted from static web pages can be translated to another language, and can identify hard-coded text strings that cannot be translated.

During GVT, a process referred to as pseudo translation or mock translation is performed on the text strings of the web application under test to proactively check for problems related to text normalization, concatenation, corruption, hard-coding, and the like that may affect translation of the application into other languages. In doing so, pseudo translation can mimic foreign languages by converting text such as English ASCII text to a different format, for example, non-ASCII text, and determine whether the source text can be translated to another language.

### BRIEF SUMMARY

In one aspect, a computer-implemented method of testing a software application includes identifying elements of a web document under test loaded in a web browser. The method further comprises outputting the elements to a plurality of string processors. The method further comprises determining by the string processors one or more accessible strings of text and locale-sensitive information from the elements. The method further comprises validating the accessible strings of text and locale-sensitive information to determine whether the strings are at least one of correctly pseudo-translated and properly formatted.

In another aspect, a computer-implemented method for managing a browser to test a software application comprises detecting a change event related to a web browser. The method further comprises freezing the web browser. The method further comprises submitting elements of a document under test loaded in the frozen web browser to a plurality of string processors. The method further comprises determining by the string processors one or more accessible strings from the received elements. The method further comprises validating the accessible strings to determine whether the strings are at least one of translatable to one or more different languages and properly formatted.

In another aspect, a browser plugin comprises a content processing module, a string processing module, and a validation module. The content processing module retrieves elements of a web document under test loaded in a web browser in communication with the browser plugin. The string processing module determines accessible strings from the retrieved elements. The validation module determines whether the accessible strings are at least one of correctly pseudo-translated and properly formatted.

In another aspect, a computer program product is provided for managing a display of pop-up windows. The computer program product comprises a computer readable storage medium having computer readable program code embodied therewith. The computer readable program code comprises computer readable program code configured to identify elements of a web document under test loaded in a web browser. The computer readable program code further comprises computer readable program code configured to output the elements to a plurality of string processors. The computer readable program code further comprises computer readable program code configured to determine one or more accessible globalized strings of text and locale-sensitive information from the elements. The computer readable program code further comprises computer readable program code configured to validate the accessible strings of text and locale-sensitive information to determine whether the strings are at least one of correctly pseudo-translated and properly formatted.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a computer system representative of a hardware environment in which the present inventive concepts can be implemented;

FIG. 2 is a block diagram of a dynamic globalization test system shown in FIG. 1, in accordance with an embodiment;

FIG. 3 is a flowchart illustrating a method for detecting and validating accessible globalized strings of text and locale-sensitive information corresponding to a web document under test, in accordance with an embodiment;

FIG. 4 is a flowchart illustrating a method for testing a web application having dynamic content, in accordance with an embodiment; and

FIG. 5 is a screenshot of a display that presents validation results, in accordance with an embodiment.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

Embodiments of the present inventive concepts address and overcoming conventional limitations related to GVT described above such as difficulty in exposing problems related to locale-sensitive behavior such as formatting currencies, dates, times, or other special variant preferences that the user wants to see in their graphical user interface (GUI). Embodiments of the present inventive concepts also validate dynamic contents associated with modern web applications can include, for example, applications created by Asynchronous JavaScript and XML (AJAX), which is also difficult using conventional approaches. A common conventional approach for testing dynamic web applications is to visual inspect the application under test to validate pseudo translation resources. In order to verify secondary text, for example, tooltip or alternative image text, additional conventional approaches such as manual triggering or source code injection can be performed. However, manual triggering is labor-intensive. Also, the effectiveness of the verification testing is dependent on the experience of the tester, and is therefore prone to human error. Application localization methods such as source code injection include the addition of source code to the web page under test for automatically loading locale property information selected by the user when the web page is loaded. In this manner, the web page can be presented to the user in a language corresponding to the locale. However, source code injection is difficult to implement and is limited in the ability to detect and verify different types of locale-sensitive data.

In brief overview, systems and methods of the present inventive concepts are provided for detecting and validating accessible text and locale of a web application based on GVT, while eliminating the need for labor-intensive or unreliable mechanisms such as source code injection or manual triggers, regardless of whether the web application includes static or dynamic content. Preferred embodiments include the implementation of the Document Object Model (DOM), which provides a logical structure, referred to as a DOM tree, of an electronic document such as a web page written in hypertext markup language (HTML), extensible hypertext markup language (XHTML), AJAX, and the like. DOM can be employed to access and retrieve the contents of the web application.

The systems and methods in accordance with embodiments of the present inventive concepts automatically inspect a DOM tree of a web application under test. This can be implemented as a browser plugin so that a web browser such as Mozilla® Firefox® can be used to perform GVT. A set of string processors are registered with the browser plugin. Elements of the inspected DOM tree that relate to the contents of the web application are output to the string processors, which identify those accessible strings that can be translated into one or more other languages.

As described above, displayed text and locale are two areas validated by GVT according to well-defined GVT rules. In accordance with an embodiment, an accessible string is validated by a pseudo translation validator, and/or other registered validators, depending on the data type being validated. If an accessible string fails during validation, the systems and methods can establish that it is neither a well-formatted pseudo-translated string nor locale-related data, and can save the document under test for report summaries and the like.

As described above, embodiments of the systems and methods described herein do not require source code inspection or manual triggering when performing GVT on a web application having dynamic content, for example, generated by AJAX. For example, transient states, for example, a progress indicator, can be captured. In addition, embodiments of the systems and methods described herein can identify and validate different application contents including text, date, time, currency, and can be extended to validate new data types. For example, an HTML element corresponding to a new local currency symbol can be added by registering a new string processor that can identify the new local currency symbol as a new data type. A new validator can be added that examines strings including the new data type.

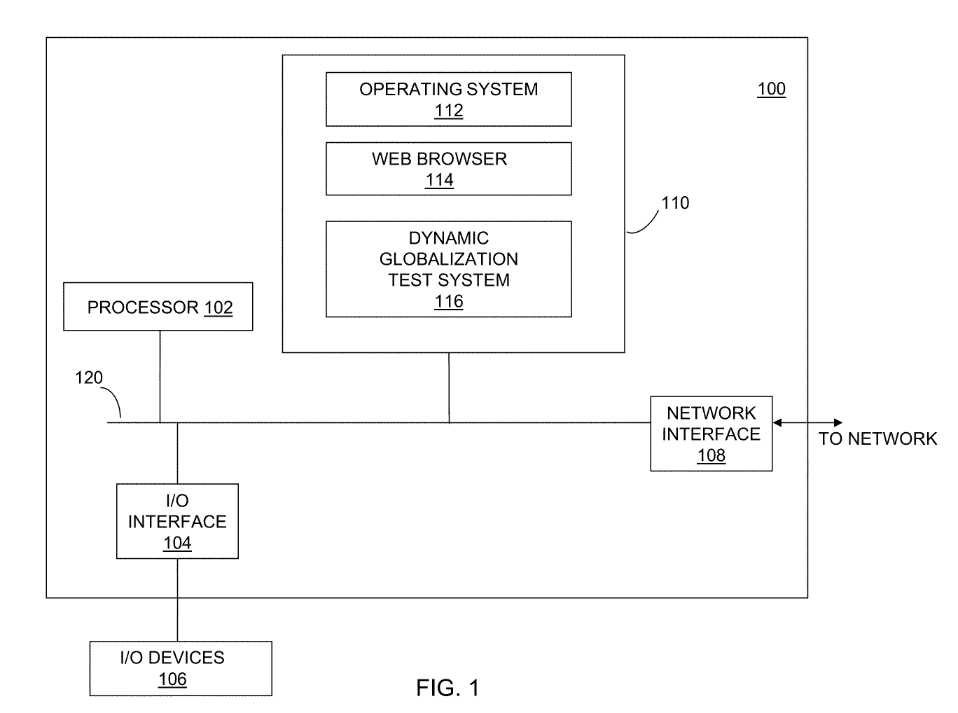

FIG. 1 is a block diagram of a computer system 100 representative of a hardware environment in which the present inventive concepts can be implemented. The computer system 100 includes, but is not limited to, at least one processor 102, for example, a CPU, an I/O interface 104, a network interface 108, and a memory 110 in communication with each other via a system bus 120.

The memory 110 can include volatile memory, for example, RAM and the like. The memory 110 can include non-volatile memory, for example, ROM, flash memory, and the like. The memory 104 can include removable and/or non-removable storage media implemented in accordance with methods and technologies known to those of ordinary skill in the art for storing data. Stored in the memory 104 can include program code, such as program code corresponding to an operating system 112, a web browser 114, and/or a dynamic globalization test system 116, each described below.

The I/O interface 104 can be in communication with one or more I/O devices 106, such as a keyboard, a mouse, a trackball, and/or a display, for example, a monitor or a touchscreen.

The network interface 108 can communicate with other electronic devices via a network (not shown) such as a WAN, LAN, Internet, public network, private network, and the like, or via a direct connection.

The operating system 112 is executed by the processor 102, and controls the functions of the various components of the computer system 100. The operating system 112 can be a commercially-available operating system such as Linux, Windows, and the like.

The web browser 114 can retrieve and present static or dynamic web pages, GUIs, or other documents related to the application under test, for example, HTML web pages, XML web pages, and the like. The web browser 114 can be a commercially-available browser that is known to those of ordinary skill in the art, for example, Mozilla® Firefox®, or other application that can retrieve and/or display visual elements such as words, images, buttons, and the like of the application under test to a user. The web browser 114 can create a DOM tree from one or more web pages of the application under test according to well-known approaches. The web browser 114 can be configured for manual or automated operation.

The dynamic globalization test system 116 can extend the capabilities of the web browser 114 by detecting and validating accessible text and locale in a application under test without the need for independent source code inspection or manual triggers. In a preferred embodiment, the dynamic globalization test system 116 includes browser plugin features for communicating with the web browser 114, for example, to implement processes according to embodiments described herein. The application under test can be a web application or a computer software program that is hosted in a browser-controlled environment. The application under test can be written in a software language such as the Java programming language, HTML, XHTML, the extensible markup language (XML), Javascript, AJAX, or a combination thereof. The application under test can utilize one or more of these software languages to provide real-time control in a separate program, eliminating the need to refresh the web browser 114.

The application under test can be developed for deployment in both English and non-English operating environments. To achieve this, some or all of the application under test can be loaded into the web browser 114 and tested using GVT to validate that strings of the application are translatable to a non-English language.

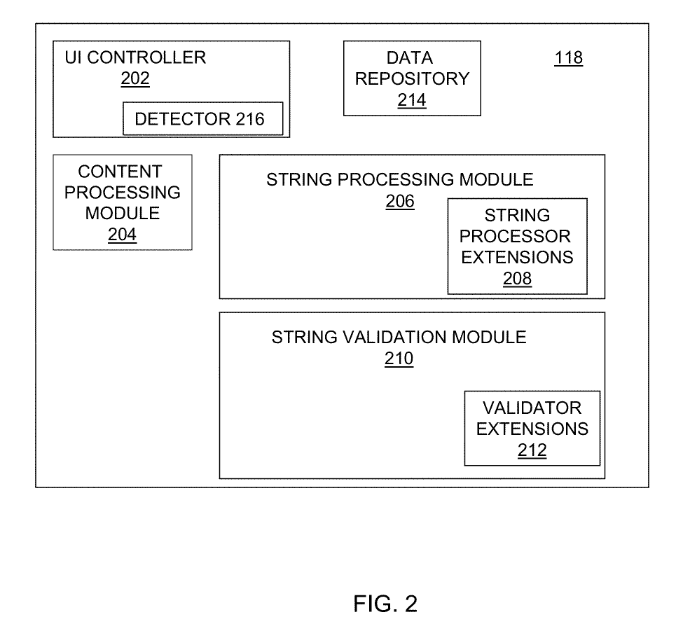

FIG. 2 is a block diagram of the dynamic globalization test system 116 shown in FIG. 1, in accordance with an embodiment. The dynamic globalization test system 116 can include a user interface (UI) controller 202, a content processing module 204, at least one string processing module 206, a string validation module 210, and a data repository 214.

The UI controller 202 can include a detector 216, also referred to as a listener, which monitors the web browser 114 for possible change events. The UI controller 202 can temporarily freeze, or pause, the web browser 114 when it detects a change event, such as a new web-based document of the application under test displayed on the web browser 114, or an update to a current web-based document displayed on the web browser 114. In an embodiment, the change event can include an AJAX change event. For example, the detector 216 can detect dynamic content such as a pending message or image, a progress indicator, and the like. When a DOM tree corresponding to a loaded webpage is changed, for example, to address transient states related to an AJAX response, the UI controller 202 can be triggered to block the DOM tree change

The content processing module 204 can access the logical structure of a document under test and inspect the elements of the DOM tree corresponding to the document under test. The DOM tree can be produced by implementing Document Object Model (DOM) in the web browser 114. The content processing module 204 can receive a signal from the UI controller 202 when the browser is paused, and automatically inspect the DOM tree after the web browser 114 is paused. In an embodiment, elements of the DOM tree, including attributes related to the DOM elements, are output from the content processing module 204 to the string processing module 206.

The string processing module 206 includes a plurality of string processors that can determine one or more accessible strings from the received DOM elements. The string processors of the string processing module 206 register with the content processing module 204 to communicate with the UI controller 202 for receiving the DOM elements. Each string processor can be configured to process one or more DOM element contents corresponding to a particular HTML element type and the like. For example, a textarea element can be provided to the string processing module 206, which includes a string processor that determines an accessible string to include mytitle and sometext.

<textarea id=“myid” title=“mytitle” style=“mystyle”>
sometext
</textarea>

Different DOM elements can use different attributes to define accessible strings identified by the string processing module 206. For example, the accessible string for an image (IMG) element can be extracted from its HTML alt attribute, which specifies an alternative text for an image if the image cannot be displayed. However, when a title attribute is identified as being in an anchor element, the accessible string for the anchor element can include both the title attribute and the contents of the anchor element, since the title attribute may contain text used to display additional information. The accessible strings can include contents, for example, binary code, that relate to a graphical image, or other text or non-text data. The string processors can send the accessible strings to the data repository 214 where they can be retrieved later for validation.

The string processing module 206 can include one or more string processor extensions 208 for adding new string processors to be added, for example, when new HTML elements are introduced. A new element types can be parsed, validated, etc. by registering a new string processor with the content processing module 204. In this manner, a new element type can be determined whether to include translatable contents for validation, or whether the contents are not translatable, for example, hard-coded strings. A new string processor can be registered in a plugin format, i.e., requiring little or no modification to the dynamic globalization test system 116, by writing the new string processor's name into a configuration (config) file, or adding the new string processor file to a directory, and the like.

The string validation module 210 can examine the identified accessible strings, for example, using GVT, and validate the strings for translation. The string validation module 210 can include one or more validation engines, such as a pseudo translation validater, and/or validators for other data types, for example, a number validator, a date validator, a currency validator, and the like. The string validation module 210 can include one or more validator extensions 212 to handle new data types. For example, a new currency validator can be added to examine strings having a local currency symbol. The validators and validator extensions 212 of the validation module 210 are each registered with the dynamic globalization test system 116 for communicating with the string processing module 206 and/or the data repository 214, for example, to receive and validate the accessible strings.

The data repository 214 can store validation results produced by the validation module 210. The data repository 214 can be part of the memory 110 or separate from the memory 110.

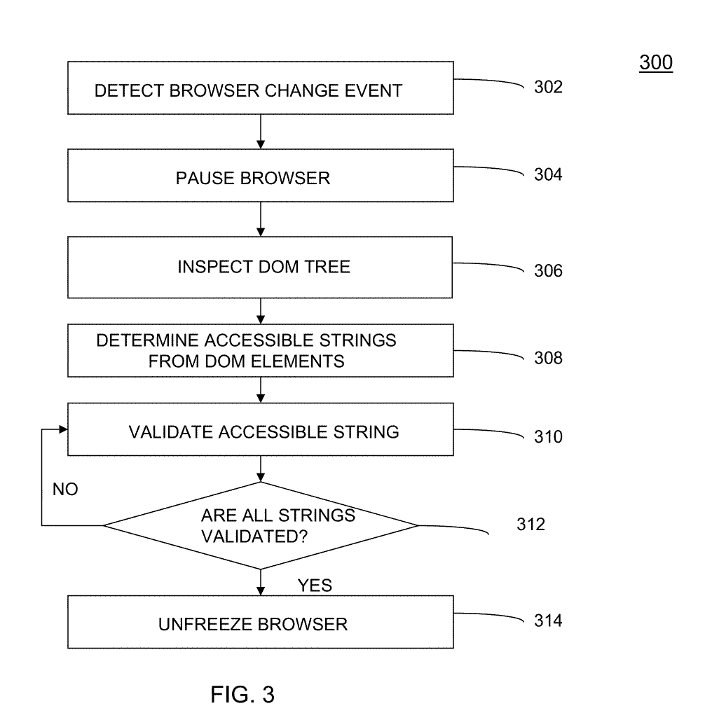

FIG. 3 is a flowchart illustrating a method 300 for detecting and validating accessible globalized strings of text and locale-sensitive information corresponding to a web document under test, in accordance with an embodiment. Some or all of the method 300 can be implemented in the dynamic globalization test system 116 described in FIG. 2. Accordingly, in describing the method 300, reference can be made to FIGS. 1 and 2.

The method 300 begins with detecting 302 a browser change event. A browser change event can be detected when a new web page is loaded into a browser, or due to an event occurring after a web page is loaded, for example, due to dynamic content generated by AJAX. A browser change event can occur when the user uses the back and forward buttons, the browser's history, or the address bar itself to change the browser's URL, or elements changed by JavaScript

The web browser 114 is temporarily paused 304, or frozen, automatically or manually in response to the detection of a browser change event. The UI controller 202 can pause the web browser 114 to prevent additional changes from occurring to the web document under test when the web document, for example, HTML elements of the web document, undergo a subsequent examination such as a DOM inspection.

The web browser 114 can generate a DOM tree from the web document under test. The DOM tree includes a set of nodes that can include various contents in the web page, such as text, dates, times, currencies, and the like. Since methods for generating a DOM tree for a web page are well-known to those of ordinary skill in the art, a detailed description thereof is omitted herein for reasons related to brevity.

The DOM tree is inspected 306 to identify contents of the web document under test, which can be translated into another language. Examples of such contents can include, but not be limited to text, currencies, dates, and other locale-related information.

A set of accessible strings is determined 308 from the results of the DOM tree inspection. The string processing module 206 can fetch the accessible strings from a received DOM element by examining the element. The accessible strings can be stored in the data repository 214 for future validation. The accessible strings can be stored in memory corresponding to a locale, and can be validated according to the locale.

At least one accessible string is validated 310. A string can be validated by one or more GVT validators of the string validation module 210, for example, a pseudo translation validator, a number validator, a date validator, and the like. Validator extensions 212 can be provided for new element types of the web document under test. For example, a currency validator can be added to examine currency strings is accord with the currency formatting of the specified locale.

A determination is made 312 as to whether all accessible strings are validated, for example, the pseudo translation is correct and the locale-sensitive data is correctly displayed according to locale. For example, locale information such as the number 12345.067 in locale zh_CN can be validated as properly displayed as 12,345.067, and in locale fr_FR can be validated as properly displayed as 12 345,067.

If yes, then the UI controller 202 can unfreeze 314 the web browser 114. If no, then the method 300 returns to block 310 to validate another accessible string.

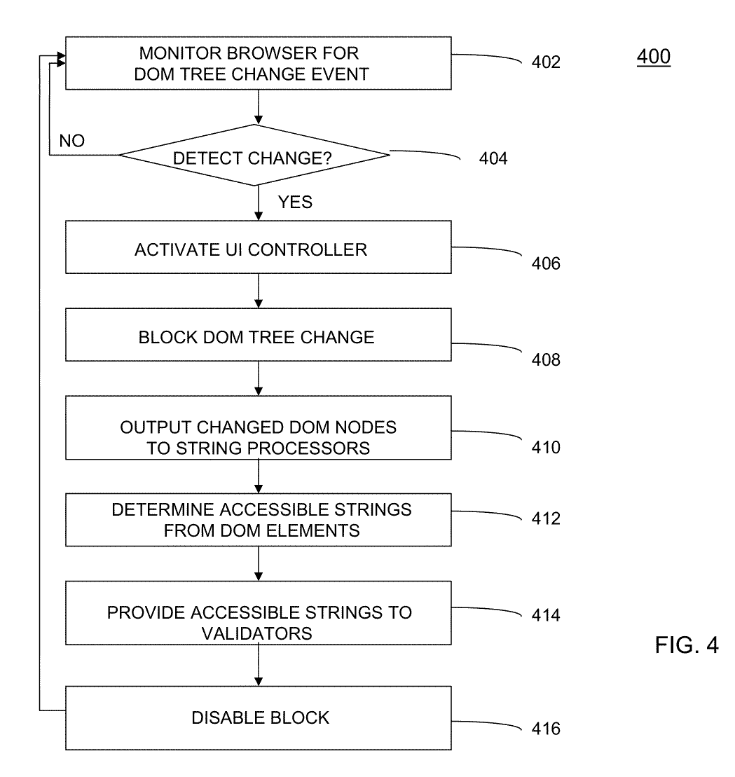

FIG. 4 is a flowchart illustrating a method 400 for testing a web application having dynamic content, in accordance with an embodiment. Some or all of the method 400 can be implemented in the dynamic globalization test system 116 described in FIG. 2. Accordingly, in describing the method 400, reference can be made to FIGS. 1 and 2.

The method 400 begins with monitoring 402 the web browser 114 for an event related to changes in a DOM tree of a web document under test, for example, using the detector 216. A DOM tree change can occur due to a text replacement or a node addition, deletion, or change. A DOM tree can also be changed when an AJAX response is processed or a pending message or image is displayed, or related events known to those of ordinary skill in the art.

If a change event related to the DOM is detected 404, then the UI controller 202 is activated 406, or triggered, to block 408 any DOM tree changes.

The UI controller 202 can block 408 a DOM tree change during inspection and/or string validation by freezing the web browser 114. For example, if an element is in a transient state, for example, due to dynamic content generated by AJAX, any attempted change to the DOM tree will be blocked by the UI controller. For example, changes corresponding to a progress indication event can be blocked.

Elements of the DOM tree, which include various contents in the web document under test such as text and locale-sensitive data, can be output 410 to the string processing module 206. And the string validation module 210 specifies a locale for proper operation. In an embodiment, the locale is manually set. In another embodiment, the locale in the DOM tree can be retrieved locally, for example, when the locale is included in HTML. For example, the following xml:lang attribute is configured to be in an html tag, and is ensured to be correct.

<html xmlns=“http://www.w3.org/1999/xhtml” xml:lang=“zh-CN”>

The string validation module is configured to specify a locale to validate whether the test the data, i.e., text and locale-sensitive data, is valid.

The string processing module 206 can determine 412 one or more accessible strings from the received DOM elements, and provide 414 each accessible string to a corresponding validator. The UI controller 202 can disable 416 any further blocking of DOM tree changes after each accessible string is validated, and listen for a next DOM tree change event by returning to block 402 of the method 400.

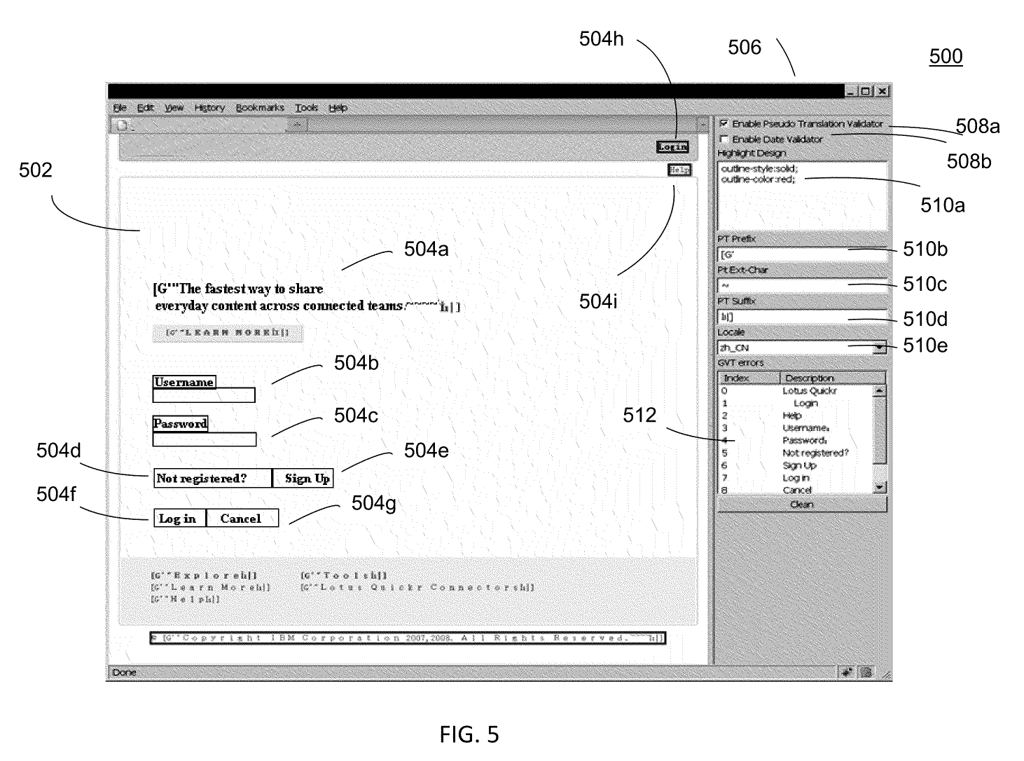

FIG. 5 is a screenshot of a display 500 that presents validation results, in accordance with an embodiment. In a preferred embodiment, the display 500 can include a web browser, for example, the web browser 114 described herein. The web browser can be an AJAX web browser for displaying dynamic content. The display 500 displays viewable contents 504a-504i of a web application under test 502, for example, text, symbols, images, and the like in the form of HTML.

The display 500 also includes a user interface 506 for validating the contents 504a-504i of the web application under test 502. The user interface 506 includes a plurality of checkboxes corresponding to a validator, for example, a pseudo translation validator checkbox 508a and a date validator checkbox 508b. When selected, a user can set GVT attributes corresponding to the selected validator. In FIG. 5, the pseudo translation validator checkbox 508a is selected. GVT attributes corresponding to the selected validator can be provided by a user, for example, a highlight design 510a, pseudo translation (PT) prefix 510c, extension character (PT Ext-Char) 510c, PT suffix 510d, or other PT format fields, locale information 510e, and the like. The user interface 506 can also display GVT errors 512 identified by the validator, for example, a pseudo translation validator of the string validation module 210.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A computer-implemented method of testing a software application, comprising:
identifying elements of a web document under test loaded in a web browser;
outputting the elements to a plurality of string processors;
determining by the string processors one or more accessible strings of text and locale-sensitive information from the elements; and
validating the accessible strings of text and locale-sensitive information to determine whether the strings are at least one of correctly pseudo-translated and properly formatted.

2. The computer-implemented method of claim 1, wherein identifying the elements of the web document under test comprises:
forming a Document Object Model (DOM) tree from the web document under test; and
inspecting the DOM tree to access the elements of the web document under test.

3. The computer-implemented method of claim 1 further comprising:
listening for browser change events; and
freezing the web browser when a browser change event is detected.

4. The computer-implemented method of claim 3 further comprising unfreezing the web browser after validating the accessible strings of text and locale-sensitive information.

5. The computer-implemented method of claim 1, wherein validating the accessible strings of text and locale-sensitive information includes implementing global verification testing (GVT).

6. The computer-implemented method of claim 1, wherein the web document under test is written in at least one of Java, hypertext markup language (HTML), extensible hypertext markup language (XHTML), extensible hypertext markup language (XML), Javascript, and AJAX.

7. The computer-implemented method of claim 1 further comprising registering the string processors with a browser plugin in communication with the web browser.

8. The computer-implemented method of claim 1, wherein outputting the elements comprises outputting dynamic content in the elements to at least one string processor.

9. A computer-implemented method for managing a browser to test a software application, comprising:
detecting a change event related to a web browser;
freezing the web browser;
submitting elements of a document under test loaded in the frozen web browser to a plurality of string processors;
determining by the string processors one or more accessible strings from the received elements; and
validating the accessible strings to determine whether the strings are translatable to one or more different languages and properly formatted.

10. The computer-implemented method of claim 9, further comprising:
forming a DOM tree from the document under test; and
inspecting the DOM tree to access the elements of the document under test.

11. The computer-implemented method of claim 9 further comprising:
listening for web browser change events; and
freezing the web browser when a web browser change event is detected.

12. The computer-implemented method of claim 9 further comprising unfreezing the web browser after validating the accessible strings.

13. The computer-implemented method of claim 9, wherein validating the accessible strings includes implementing GVT.

14. The computer-implemented method of claim 9, wherein validating the accessible strings includes determining whether text and locale-sensitive information of the strings are at least one of correctly pseudo-translated and properly formatted for display.

15. The computer-implemented method of claim 9, wherein the document under test is written in at least one of Java, hypertext markup language (HTML), extensible hypertext markup language (XHTML), extensible hypertext markup language (XML), Javascript, and AJAX.

16. The computer-implemented method of claim 9 further comprising registering string processors with a browser plugin in communication with the web browser.

17. The computer-implemented method of claim 9, wherein submitting the elements comprises outputting dynamic content in the elements to at least one string processor.

18. A browser plugin comprising:
a content processing module that retrieves elements of a web document under test loaded in a web browser in communication with the browser plugin;
a string processing module that determines accessible strings from the retrieved elements; and
a validation module that determines whether the accessible strings are at least one of correctly pseudo-translated and properly formatted.

19. The browser plugin of claim 18 further comprising a user interface controller that freezes the web browser so that the content processing module can retrieve the elements of the web document under test, and unfreezes the web browser after the elements are retrieved.

20. The browser plugin of claim 19, wherein the user interface controller includes a listener that monitors the web browser for change events, and freezes the web browser in response to detecting a change event.

21. A computer program product for managing a display of pop-up windows, the computer program product comprising:
a computer readable storage medium having computer readable program code embodied therewith, the computer readable program code comprising;
computer readable program code configured to identify elements of a web document under test loaded in a web browser;
computer readable program code configured to output the elements to a plurality of string processors;
computer readable program code configured to determine one or more accessible globalized strings of text and locale-sensitive information from the elements;
computer readable program code configured to validate the accessible strings of text and locale-sensitive information to determine whether the strings are at least one of correctly pseudo-translated and properly formatted.
